(19) United States
(12) Patent Application Publication
(10) Pub. No.: US 2013/0192521 A1
(43) Pub. Date: Aug. 1, 2013

(54) SHADOW MASK AND COMPENSATING DESIGN METHOD THEREOF

(71) Applicants: Chi-Pao CHU, Chu Nan (TW); I-Tang JIANG, Chu-Nan (TW); Sz-Hsiao CHEN, Chu-Nan (TW); Kuan-Yi YANG, Chu-Nan (TW); Kuan-Chou CHEN, Chu-Nan (TW); Yi-Hui LEE, Chu-Nan (TW); Chin-Kuei WEN, Chu-Nan (TW)

(72) Inventors: Chi-Pao CHU, Chu Nan (TW); I-Tang JIANG, Chu-Nan (TW); Sz-Hsiao CHEN, Chu-Nan (TW); Kuan-Yi YANG, Chu-Nan (TW); Kuan-Chou CHEN, Chu-Nan (TW); Yi-Hui LEE, Chu-Nan (TW); Chin-Kuei WEN, Chu-Nan (TW)

(73) Assignee: INNOLUX CORPORATION, Chu-Nan (TW)

(21) Appl. No.: 13/753,728

(22) Filed: Jan. 30, 2013

(30) Foreign Application Priority Data
Jan. 30, 2012 (TW) 101102781

(51) Int. Cl. B05C 21/00

(52) U.S. Cl. CPC B05C 21/005
USPC 118/504; 427/282

(57) ABSTRACT

The disclosure provides a compensating design method for a shadow mask including: providing a first shadow mask having a first opening pattern and a first material pattern; disposing the first shadow mask on a substrate having a predetermined depositing film area with first and second sides; performing a deposition process by using the first shadow mask as a mask to form a film on an actual depositing film area, wherein the distance between the first and the third sides is a first bias, and the distance between the second and the fourth sides is a second bias, and a single side gray zone of the actual depositing film area relative to the predetermined depositing film area is substantially half of the sum of the first and the second biases; and designing a second shadow mask according to the single side gray zone.

### CROSS REFERENCE TO RELATED APPLICATIONS

This application claims priority of Taiwan Patent Application No. 101102781, filed on Jan. 30, 2012, the entirety of which is incorporated by reference herein.

### BACKGROUND OF THE INVENTION

1. Field of the Invention

The present invention relates to a mask and a compensating design method thereof, and in particular relates to a shadow mask and a compensating design method thereof.

2. Description of the Related Art

The current manufacturing processes of liquid crystal displays mainly use photolithography and etching to form films on glass substrates, so as to form active devices and passive devices on glass substrates. It is not only time-consuming, but also costs a lot of money to form films by using photolithography and etching. Thus, for increasing production rates and lowering production costs, industries have developed a film-forming method using sputtering with a shadow mask, so as to form patterned films on glass substrates. However, the patterned films formed by using the shadow mask have disadvantages, including a low pattern resolution and a large line-width variation, and thus the shadow mask is only suitable for forming protective layers or passivation layers with low pattern fineness requirements.

When the film-forming method using the shadow mask is applied on small-size glass substrates (smaller than generation 3.5), the misalignment of the film is acceptable. However, as the glass substrate becomes increasingly larger, the deformation of the glass substrate likewise becomes increasingly larger, due to the mechanism and the temperature of the deposition process of the film. The deformation of the large-size glass substrate decreases the covering accuracy of the shadow mask, which decreases the pattern resolution and increases the line-width variation to exceed the process tolerance. Thus, it is imperative to develop new technology to achieve a film-forming method using a shadow mask that may be applied on large-size glass substrates.

### BRIEF SUMMARY OF THE INVENTION

An embodiment of the disclosure provides a compensating design method for a shadow mask which includes providing a first shadow mask on a substrate, wherein the first shadow mask has a first material pattern and a first opening pattern complementary to the first material pattern, the first material pattern covers a first predetermined film opening area of the substrate, and the first predetermined film opening area has a first side and a second side opposite to the first side on an axis. A deposition process is performed by using the first shadow mask as a mask to form a film on the substrate, wherein the film has a first opening under the first material pattern; the first opening has a third side and a fourth side opposite to the third side on the axis; the first side is adjacent to the third side, and the second side is adjacent to the fourth side, wherein the distance between the first and the third sides is a first bias, the distance between the second and the fourth sides is a second bias, and a first single side gray zone of the first opening relative to the first predetermined film opening area is substantially half of the sum of the first and the second biases. A second shadow mask is designed according to the first single side gray zone, wherein the second shadow mask is similar to, but different from, the first shadow mask. The second shadow mask has a second material pattern and a second opening pattern complementary to the second material pattern, and the size of the second opening pattern is different from that of the first opening pattern.

An embodiment of the disclosure provides a shadow mask, which includes a material pattern and an opening pattern complementary to the material pattern, wherein the material pattern includes a plurality of pattern units arranged in an array. The pattern units include at least a first pattern unit and a second pattern unit, wherein the first pattern unit has a first base pattern and a first compensation pattern extending from a fringe of the first base pattern toward the opening pattern along an axis, and the second pattern unit has a second base pattern and a second compensation pattern extending from a fringe of the second base pattern toward the opening pattern along the axis. The size and the shape of the first base pattern is the same as that of the second base pattern. The extension distance of the first compensation pattern is not equal to the extension distance of the second compensation pattern.

A detailed description is given in the following embodiments with reference to the accompanying drawings.

### BRIEF DESCRIPTION OF THE DRAWINGS

The present disclosure can be more fully understood by reading the subsequent detailed description and examples with references made to the accompanying drawings, wherein:

FIGS. 1-3 are top views of a first opening pattern of a shadow mask and a film according to embodiments of the present disclosure;

FIGS. 4A-4D are process cross-sectional views showing a compensation design method for a shadow mask according to an embodiment of the present disclosure;

FIGS. 5A-5D are top views of the shadow mask and a substrate of FIGS. 4A-4D;

FIGS. 6A-6D are process cross-sectional views showing a compensation design method for a shadow mask according to another embodiment of the present disclosure;

FIGS. 7A-7D are top views of the shadow mask and a substrate of FIGS. 6A-6D;

FIGS. 8A-8C are schematic diagrams of a manufacturing process for a film according to an embodiment of the present disclosure, wherein FIGS. 8A and 8C are top views, and FIG. 8B is a cross-sectional view; and

FIG. 9 is the top view of a shadow mask of another embodiment of the present disclosure.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

It is understood that the following disclosure provides many different embodiments, or examples, for implementing different features of the invention. Specific examples of components and arrangements are described below to simplify the present disclosure. These are, of course, merely examples and are not intended to be limiting. In addition, the present disclosure may repeat reference numbers and/or letters in the various examples. This repetition is for the purpose of simplicity and clarity and does not in itself dictate a relationship between the various embodiments and/or configurations discussed. Furthermore, descriptions of a first layer “on,” “overlying,” (and like descriptions) a second layer include embodiments where the first and second layers are in direct contact and those where one or more layers are interposing the first and second layers.

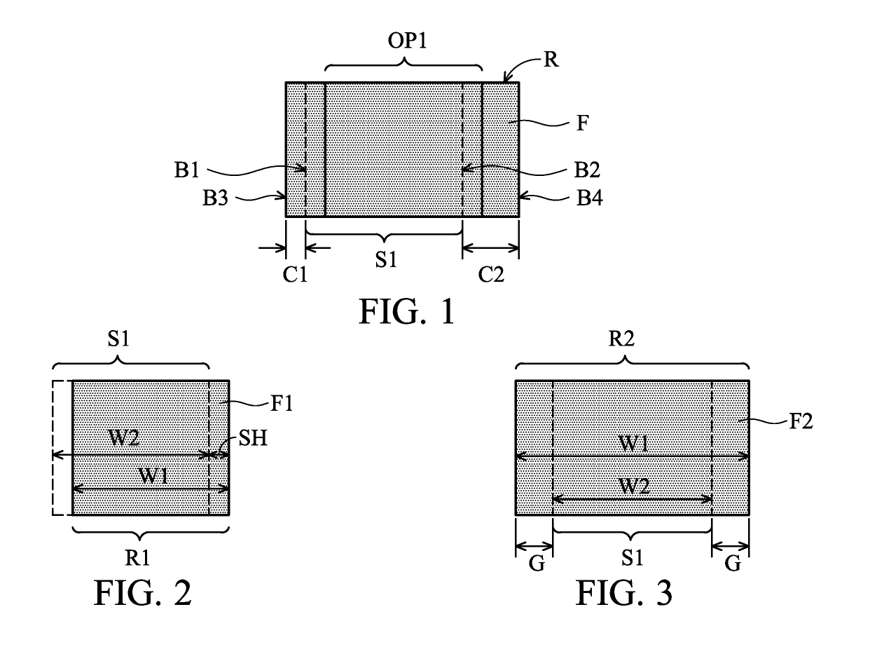

FIGS. 1-3 are top views of a film and a predetermined depositing film area of a substrate according to embodiments of the present disclosure. It should be noted that, for the sake of simplicity, the substrate and first shadow mask disposed thereon are omitted, and FIG. 1 merely shows a first opening pattern of the first shadow mask, the predetermined depositing film area of the substrate, and the film. FIGS. 2 and 3 show the predetermined depositing film area of the substrate and the film.

Referring to FIG. 1, a first shadow mask may be disposed on a substrate, wherein the first shadow mask has a first opening pattern OP1, and the substrate has a predetermined depositing film area S1 (i.e. the area designed for depositing a film; the designed value). The first opening pattern OP1 exposes a portion of the predetermined depositing film area S1.

When the first shadow mask is disposed on the substrate, there is an unavoidable misalignment between the first shadow mask and the substrate. Thus, the first opening pattern OP1 may expose only the portion of the predetermined depositing film area S1. Then, a film F is formed by using the first shadow mask as a deposition mask, and the film F is located in an actual depositing film area R (i.e. the actual value) of the substrate.

The difference between the predetermined depositing film area S1 and the actual depositing film area R is referred to as “bias” by the applicant. The bias includes a first bias C1 on the left side of the predetermined depositing film area S1 and a second bias C2 on the right side of the predetermined depositing film area S1.

Specifically, the predetermined depositing film area S1 has a first side B1 and a second side B2 opposite thereto on an axis AX, and the actual depositing film area R has a third side B3 and a fourth side B4 opposite thereto on the axis AX, wherein the first side B1 is adjacent to the third side B3, and the second side B2 is adjacent to the fourth side B4. The distance between the first side B1 and the third side B3 is the first bias C1, and the distance between the fourth side B4 and the second side B2 is the second bias C2. It should be noted that the axis AX may be an X-axis, a Y-axis, or other suitable axes.

The applicant analyzes the bias and submits that there are two factors (i.e. a first factor and a second factor) resulting in the bias. With respect to the first factor, in the manufacturing process of the film, the misalignment exists between the first shadow mask and the substrate, which results in the actual depositing film area R being shifted to the left or right by a distance relative to the predetermined depositing film area S1. In this case, the shifting distance is referred to as “shift” by the applicant. With respect to the second factor, in the deposition of the film, film diffusion characteristics result in the fringe of the film extending out of the predetermined depositing film area S1 (the designed value). In this case, the fringe of the film extends a distance from the predetermined depositing film area S1, and the distance is referred to as “single side gray zone”.

FIG. 2 shows the top view of the first opening pattern of the first shadow mask and the film, wherein the deposition of the film is only affected by the misalignment between the first shadow mask and the substrate, and not affected by other factors. It can be seen in FIG. 2 that the actual depositing film area R1, where a film F1 is located, shifts to the right by a shift SH relative to the predetermined depositing film area S1. In this case, the size (e.g. the width W1) of the film F1 is equal to the size (e.g. the width W2) of the predetermined depositing film area S1.

FIG. 3 shows the top view of the first opening pattern of the first shadow mask and the film, wherein the deposition of the film is only affected by film diffusion characteristics, and not affected by other factors. It can be seen in FIG. 3 that an actual depositing film area R2, where a film F2 is located, extends leftward and rightward for a single side gray zone G relative to the predetermined depositing film area S1. In this case, the width W1 of the film F2 is larger than the width W2 of the predetermined depositing film area S1.

In general, the manufacturing process of the film is affected by the two factors at the same time, and thus as shown in FIG. 1, the bias of the film F is affected by the shift SH and the single side gray zone G at the same time.

The applicant assumes that the shifts SH of the neighboring areas (e.g. the first side B1 and the second side B2 of the predetermined depositing film area S1) are equal to each other to calculate the shift SH and the single side gray zone G of the neighboring areas by using the biases (e.g. the first bias C1 and the second bias C2) of the neighboring areas.

The Applicant derives the following formulas:

shift SH=(second bias C2−first bias C1)/2 (formula 1)

single side gray zone G=(second bias C2+first bias C1)/2 (formula 2)

Thus, the shift SH and the single side gray zone G may be calculated according to the above formulas, and a second shadow mask with a second opening pattern may be designed according to the shift SH and the single side gray zone G. The second shadow mask has a base pattern the same as the first shadow mask and a compensation pattern extending from the fringe of the base pattern toward the second opening pattern along the axis AX, the extension distance D of the compensation pattern is substantially equal to the single side gray zone G.

That is to say, the opening pattern of the shadow mask may be reduced according to the single side gray zone G to offset (or compensate for) the effect of film diffusion characteristics on the manufacturing process of the film. In this case, the film formed by using the second shadow mask with the compensation design is similar to the film F1 shown in FIG. 2. Accordingly, the film of the present disclosure can be free from the influence of film diffusion characteristics to achieve improved pattern resolution and minimize the line-width variation.

Manufacturing processes of embodiments according to the present disclosure are described in detail as follows.

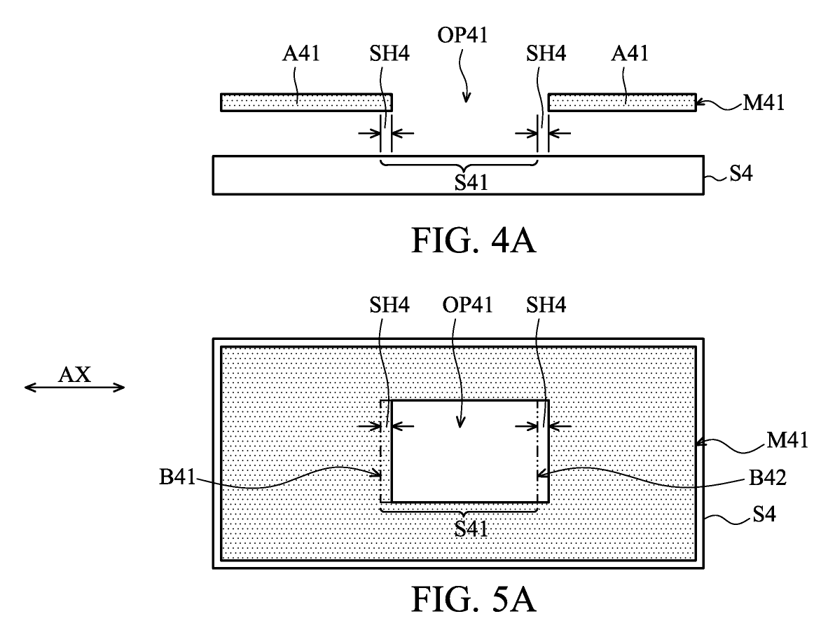

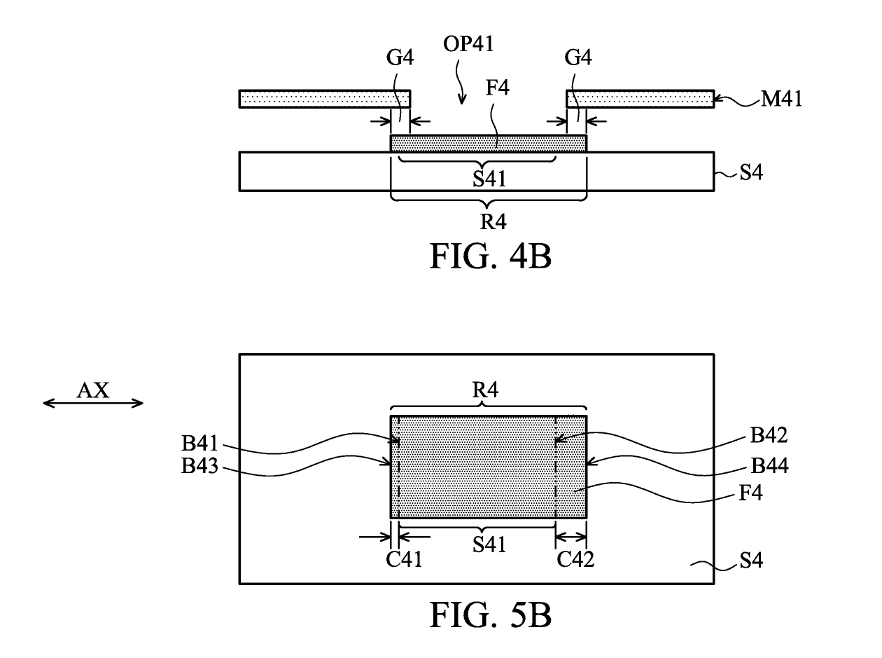

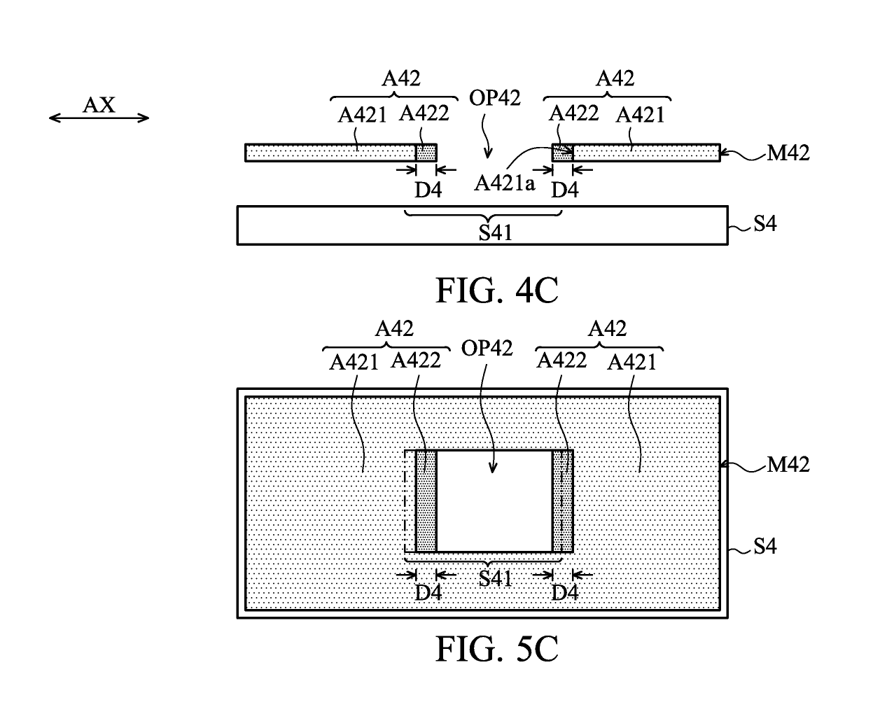

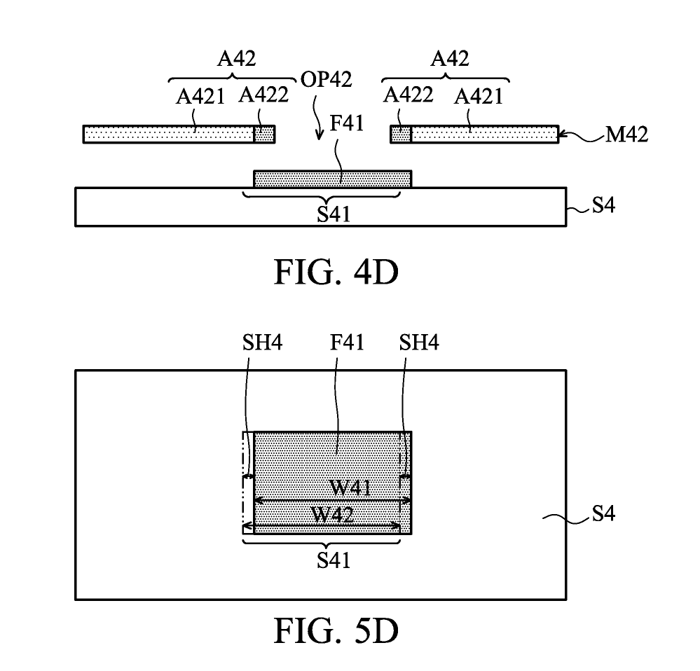

FIGS. 4A-4D are process cross-sectional views showing a compensation design method for a shadow mask according to an embodiment of the present disclosure. FIGS. 5A-5D are top views of the shadow mask and a substrate of FIGS. 4A-4D.

Referring to FIGS. 4A and 5A, a first shadow mask M41 is firstly provided, and the first shadow mask M41 has a first opening pattern OP41 and a first material pattern A41 complementary to the first opening pattern OP41. Then, the first shadow mask M41 is disposed on a substrate S4, and the first opening pattern OP41 exposes a predetermined depositing film area S41 of the substrate S4, wherein the predetermined depositing film area S41 has a first side B41 and a second side B42 opposite thereto on an axis AX.

In general, there is an unavoidable misalignment between the first shadow mask M41 and the substrate S4 in the disposing of the first shadow mask M41 on the substrate S4. Therefore, there is a shift between the first opening pattern OP41 and the predetermined depositing film area S41. FIGS. 4A and 5A show that the first opening pattern OP41 is shifted to the right by a shift SH4 relative to the predetermined depositing film area S41.

Then, referring to FIGS. 4B and 5B, a deposition process is performed by using the first shadow mask M41 as a mask to form a film F4 on the substrate S4. Specifically, the film F4 is located on an actual depositing film area R4 of the substrate S4, wherein the actual depositing film area R4 has a third side B43 and a fourth side B44 opposite thereto on the axis AX, the first side B41 is adjacent to the third side B43, and the second side B42 is adjacent to the fourth side B44. The distance between the first side B41 and the third side B43 is a first bias C41. The distance between the fourth side B44 and the second side B42 is a second bias C42.

It can be determined from formula 2 that, in the present embodiment, a single side gray zone of the actual depositing film area R4 in comparison to the predetermined depositing film area S41 is half of the sum of the first bias C41 and the second bias C42. Thus, in this case, the single side gray zone may be calculated by using the first bias C41 and the second bias C42.

In fact, as shown in FIG. 4B, said film diffusion characteristics mean that the film F4 may extent to the outside of the area of the substrate exposed by the first opening pattern OP41 by a single side gray zone G4, and the single side gray zone G4 may be calculated by using the first bias C41 and the second bias C42.

Then, referring to FIGS. 4C and 5C, a second shadow mask M42 may be designed according to the calculated single side gray zone. Specifically, the second shadow mask M42 may have a second opening pattern OP42 and a second material pattern A42 complementary to the second opening pattern OP42, wherein the second material pattern A42 has a base pattern A421 the same as the first material pattern A41 and a compensation pattern A422 extending from the fringe A421a of the base pattern A421 to the second opening pattern OP42 along the axis AX, wherein the extension distance D4 of the compensation pattern A422 is substantially equal to the single side gray zone. In one embodiment, the second opening pattern OP42 has a different shape than the first opening pattern OP41. For example, the first opening pattern OP41 is rectangular in shape, and the second opening pattern OP42 is square in shape.

Then, referring to FIGS. 4D and 5D, a deposition process is performed by using the second shadow mask M42 as a mask to form a film F41 on the substrate S4. For simplicity, FIG. 5D omits the second shadow mask M42. The width W41 of the film F41 is similar to the width W42 of the predetermined depositing film area S41. In this case, the film F41 is only affected by the misalignment, such that the film F41 is shifted to the right by a shift SH4 relative to the predetermined depositing film area S41.

It can be determined from the above that, in the present embodiment, a deposition process is firstly performed by using the first shadow mask M41 to measure the first bias C41 and the second bias C42 of the film F4, so as to calculate the single side gray zone, and then the second shadow mask M42 is designed according to the calculated single side gray zone to offset (or compensate for) the effect of film diffusion characteristics on the manufacturing process of the film. Accordingly, the film F41 of the present embodiment can be free from the influence of film diffusion characteristics to achieve improved pattern resolution and minimize the line-width variation.

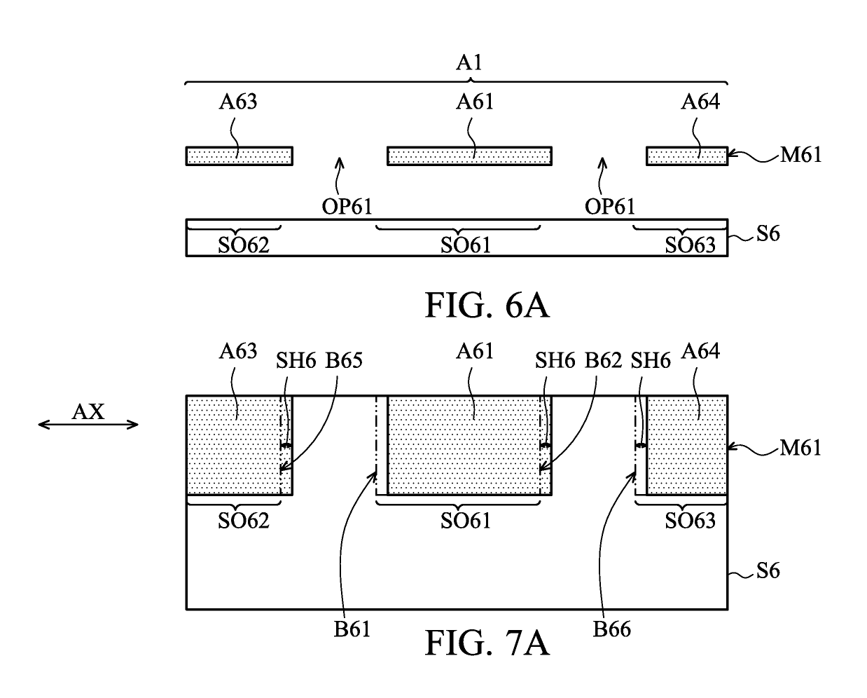

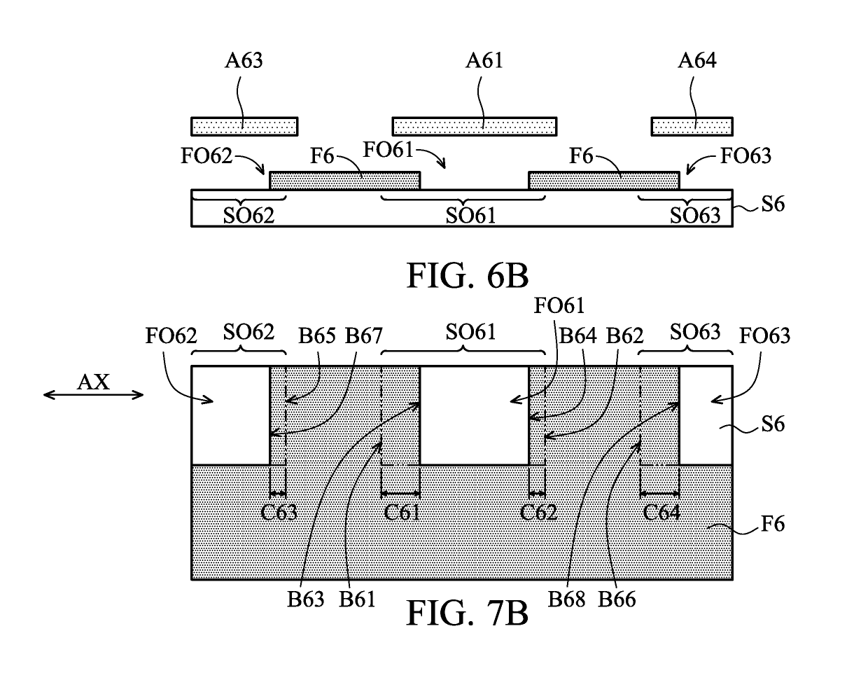

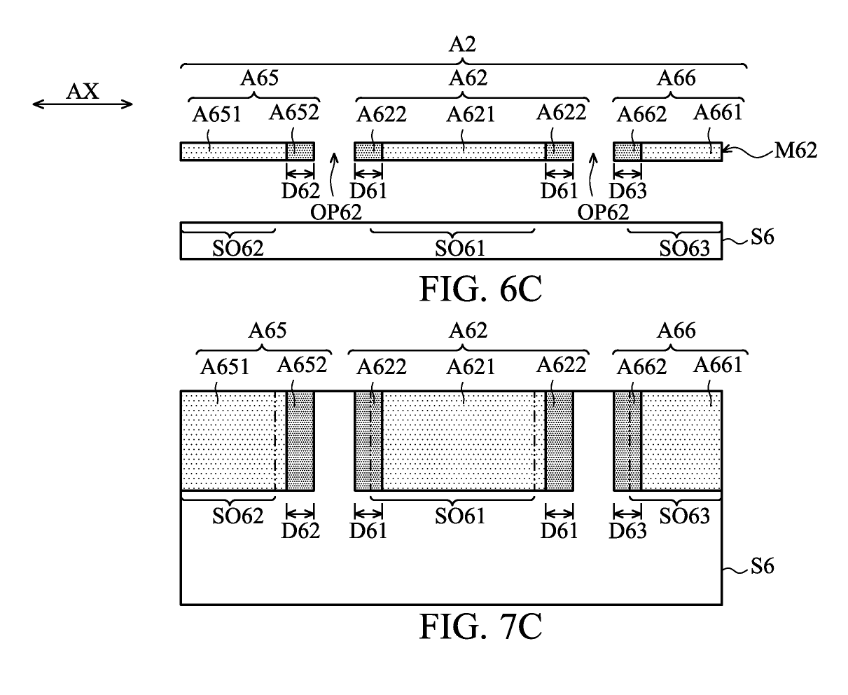

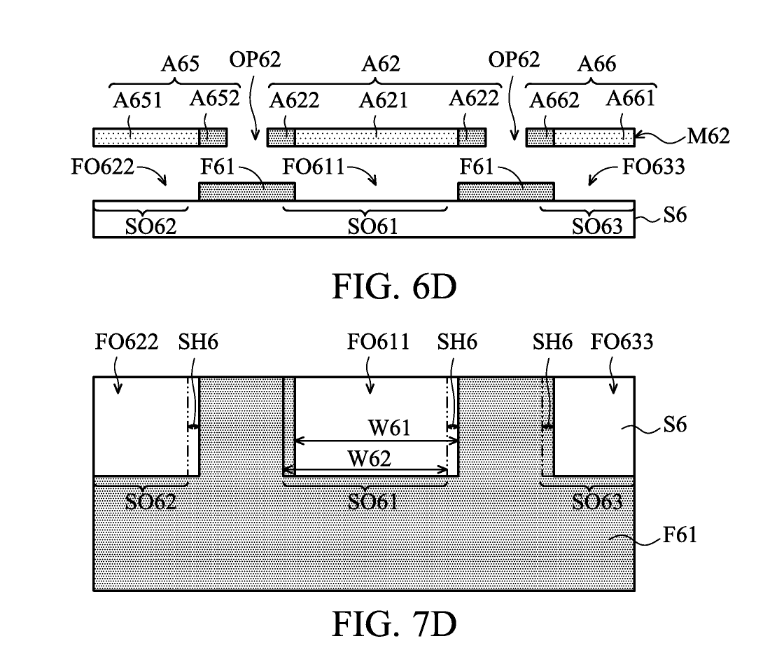

FIGS. 6A-6D are process cross-sectional views showing a compensation design method for a shadow mask according to another embodiment of the present disclosure. FIGS. 7A-7D are top views of the shadow mask and a substrate of FIGS. 6A-6D.

Referring to FIGS. 6A and 7A, a first shadow mask M61 is firstly provided, and the first shadow mask M61 has a first material pattern A1 and a first opening pattern OP61 complementary to the first material pattern A1. The first material pattern A1 includes a first pattern A61.

Then, the first shadow mask M61 is disposed on a substrate S6, and the first pattern A61 covers a first predetermined film opening area SO61 of the substrate S6, wherein the first predetermined film opening area SO61 has a first side B61 and a second side B62 opposite thereto on an axis AX.

In one embodiment, the first material pattern A1 may optionally include a first edge pattern A63 and a third edge pattern A64 located on the two opposite sides of the first pattern A61. The first opening pattern OP61 is complementary to the first edge pattern A63 and the third edge pattern A64. The first edge pattern A63 and the third edge pattern A64 respectively cover a second predetermined film opening area SO62 and a third predetermined film opening area SO63 of the substrate S6. The second predetermined film opening area SO62 and the third predetermined film opening area SO63 respectively have a fifth side B65 and a seventh side B66 on the axis AX.

In general, there is an unavoidable misalignment between the first shadow mask M61 and the substrate S6 in the disposing of the first shadow mask M61 on the substrate S6. Therefore, there is a shift between the first pattern A61 and the first predetermined film opening area SO61. FIGS. 6A and 7A show that the first pattern A61 is shifted to the right by a shift SH6 relative to the first predetermined film opening area SO61.

Similarly, the first edge pattern A63 and the third edge pattern A64 are shifted to the right by the shift SH6 respectively relative to the second predetermined film opening area SO62 and the third predetermined film opening area SO63.

Then, referring to FIGS. 6B and 7B, a deposition process is performed by using the first shadow mask M61 as a mask to form a film F6 on the substrate S6. The film F6 has a first opening FO61 under the first pattern A61, wherein the first opening FO61 has a third side B63 and a fourth side B64 opposite thereto on the axis AX, the first side B61 is adjacent to the third side B63, and the second side B62 is adjacent to the fourth side B64.

Specifically, the distance between the first side B61 and the third side B63 is a first bias C61. The distance between the fourth side B64 and the second side B62 is a second bias C62. It can be determined from formula 2 that a first single side gray zone of the first opening FO61 in comparison to the first predetermined film opening area SO61 is half of the sum of the first bias C61 and the second bias C62. Thus, the first single side gray zone may be calculated by using the first bias C61 and the second bias C62.

Furthermore, it can be determined from formula 1 that a shift SH6 of the first opening FO61 relative to the first predetermined film opening area SO61 is half of the difference between the first bias C61 and the second bias C62. Therefore, the shift SH6 may be calculated by using the first bias C61 and the second bias C62.

In one embodiment, the film F6 may optionally have a second opening FO62 under the first edge pattern A63 and a third opening FO63 under the third edge pattern A64. The second opening FO62 has a sixth side B67 adjacent to the fifth side B65 on the axis AX, and the third opening FO63 has an eighth side B68 adjacent to the seventh side B66 on the axis AX.

Specifically, the distance between the fifth side B65 and the sixth side B67 is a third bias C63, and the distance between the eighth side B68 and the seventh side B66 is a fourth bias C64. A second single side gray zone of the second opening FO62 relative to the second predetermined film opening area SO62 may be obtained by the following formula 3.

second single side gray zone=third bias C3+shift SH6 (formula 3)

A third single side gray zone of the third opening FO63 relative to the third predetermined film opening area SO63 may be obtained by the following formula 4.

third single side gray zone=fourth bias C4−shift SH6 (formula 4)

Then, referring to FIGS. 6C and 7C, a second shadow mask M62 may be designed according to the first single side gray zone. The second shadow mask M62 may have a second material pattern A2 and a second opening pattern OP62 complementary to the second material pattern A2. The second opening pattern OP62 has a different size than the first opening pattern OP61. In one embodiment, the second opening pattern OP62 inwardly shrinks the first single side gray zone relative to the first opening pattern OP61. The second material pattern A2 includes a second pattern A62.

Specifically, the second pattern A62 has a first base pattern A621 the same as the first pattern A61 and a first compensation pattern A622 extending from the fringe of the first base pattern A621 to the second opening pattern OP62 along the axis AX, wherein the extension distance D61 of the first compensation pattern A622 is substantially equal to the first single side gray zone.

In one embodiment, the second material pattern A2 may optionally further have a second edge pattern A65 and a fourth edge pattern A66, and the second opening pattern OP62 is complementary to the second edge pattern A65 and the fourth edge pattern A66.

In comparison with the first opening pattern OP61 of the first shadow mask M61, in the second shadow mask M62, the portion of the second opening pattern OP62 adjacent to the second pattern A62 inwardly shrinks the first single side gray zone. The portion of the second opening pattern OP62 adjacent to the second edge pattern A65 inwardly shrinks the second single side gray zone. The portion of the second opening pattern OP62 adjacent to the fourth edge pattern A66 inwardly shrinks the third single side gray zone.

Specifically, the second edge pattern A65 has a second base pattern A651 the same as the first edge pattern A63 and a second compensation pattern A652 extending from the fringe of the second base pattern A651 to the second opening pattern OP62 along the axis AX, and the extension distance D62 of the second compensation pattern A652 is substantially equal to the second single side gray zone.

The fourth edge pattern A66 has a third base pattern A661 the same as the third edge pattern A64 and a third compensation pattern A662 extending from the fringe of the third base pattern A661 to the second opening pattern OP62 along the axis AX, and the extension distance D63 of the third compensation pattern A662 is substantially equal to the third single side gray zone.

In one embodiment, the second opening pattern OP62 has a different shape than the first opening pattern OP61.

Then, referring to FIGS. 6D and 7D, a deposition process is performed by using the second shadow mask M62 as a mask to form a film F61 on the substrate S6. For simplicity, FIG. 7D omits the second shadow mask M62. The film F61 has a first opening FO611, a second opening FO622, and a third opening FO633 respectively corresponding to the second pattern A62, the second edge pattern A65, and the fourth edge pattern A66, wherein the width W61 of the first opening FO611 is similar to the width W62 of the first predetermined film opening area SO61.

In this case, the first opening FO611, the second opening FO622, and the third opening FO633 of the film F61 are only affected by the misalignment, and thus are shifted to the right by a shift SH6 respectively relative to the first predetermined film opening area S061, the second predetermined film opening area SO62, and the third predetermined film opening area SO63.

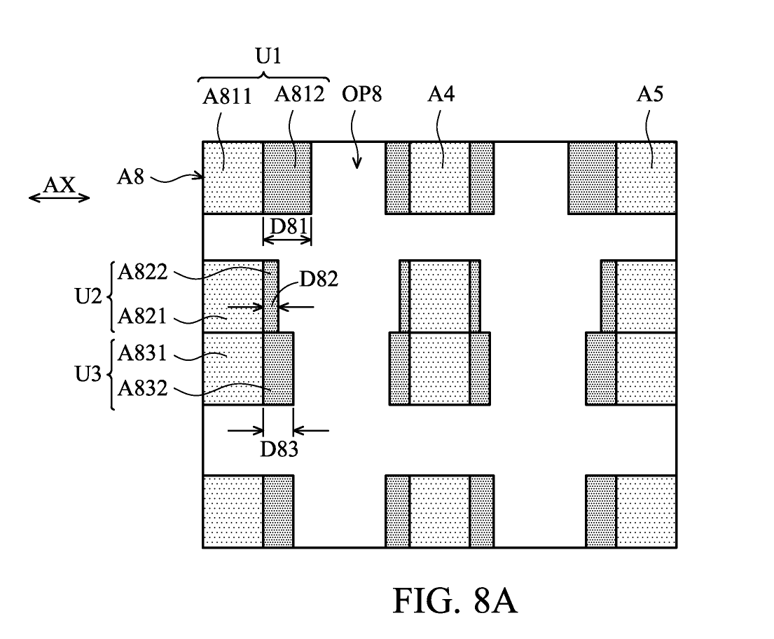

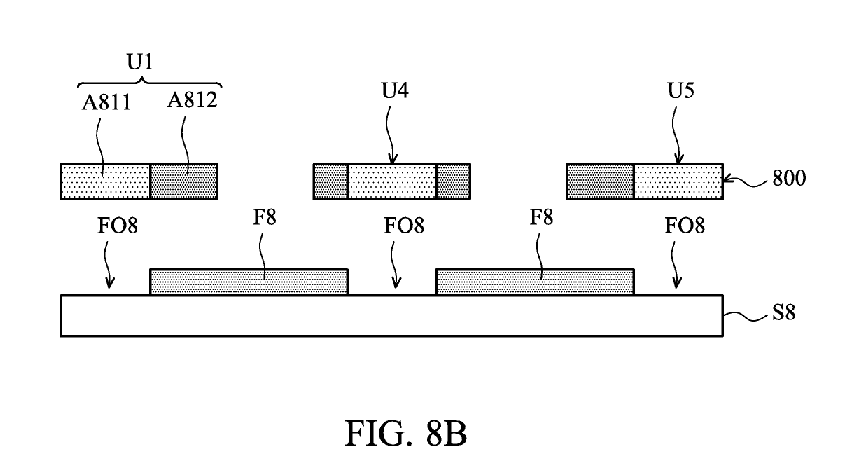

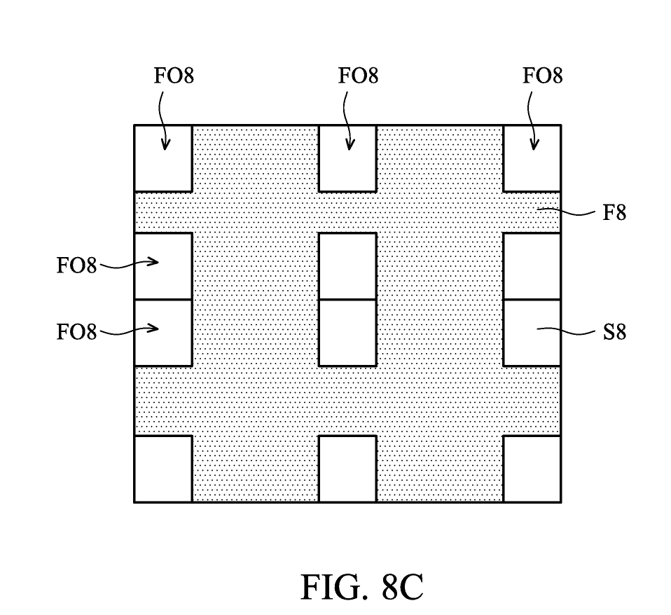

FIGS. 8A-8C are schematic diagrams of a manufacturing process of a film according to an embodiment of the present disclosure, wherein FIGS. 8A and 8C are top views, and FIG. 8B is a cross-sectional view. Referring to FIG. 8A, a shadow mask 800 of the present embodiment includes a material pattern A8 and an opening pattern OP8 complementary to the material pattern A8. The material pattern A8 includes a plurality of pattern units arranged in an array, and the pattern units may include a first pattern unit U1 and a second pattern unit U2.

Specifically, the first pattern unit U1 has a first base pattern A811 and a first compensation pattern A812 extending from the fringe of the first base pattern A811 to the opening pattern OP8 along an axis AX. The first compensation pattern A812 has, for example, a straight fringe.

The second pattern unit U2 has a second base pattern A821 and a second compensation pattern A822 extending from the fringe of the second base pattern A821 to the opening pattern OP8 along the axis AX.

The size and the shape of the first base pattern A811 is the same as that of the second base pattern A821, and the extension distance D81 of the first compensation pattern A812 is not equal to the extension distance D82 of the second compensation pattern A822. In one embodiment, the extension distance D81 of the first compensation pattern A812 is larger than the extension distance D82 of the second compensation pattern A822.

In one embodiment, the pattern units may further include a third pattern unit U3, and the third pattern unit U3 has a third base pattern A831 and a third compensation pattern A832 extending from the fringe of the third base pattern A831 to the opening pattern OP8 along the axis AX.

Specifically, the first base pattern A811, the second base pattern A821, and the third base pattern A831 have the same shape and size, the third base pattern A831 is connected to the second base pattern A821, and the extension distance D81 of the first compensation pattern A812, the extension distance D82 of the second compensation pattern A822, and the extension distance D83 of the third compensation pattern A832 are different from each other.

Different portions of the substrate (especially for large-size substrates) for deposition of the film have different variations in the manufacturing process, and thus the film has different single side gray zones corresponding to the different portions of the substrate. Therefore, the pattern units U1, U2, and U3 of the shadow mask corresponding to different portions of the film (or the opening of the film) respectively have compensation patterns with different extension distances to offset the different single side gray zones resulting from the different variations of the different portions of the substrate.

Referring to FIG. 8B, the shadow mask 800 may be used in a deposition process to form a film F8 on a substrate S8. FIG. 8C is a top view of the film F8. Referring to FIGS. 8B and 8C, the film F8 has a plurality of openings FO8 arranged in an array, and the openings FO8 have the same shape and size. The pattern units U1, U2, U3, U4, and U5 are respectively on the openings FO8, and the area of the first base pattern A811 is substantially equal to that of the opening FO8 thereunder.

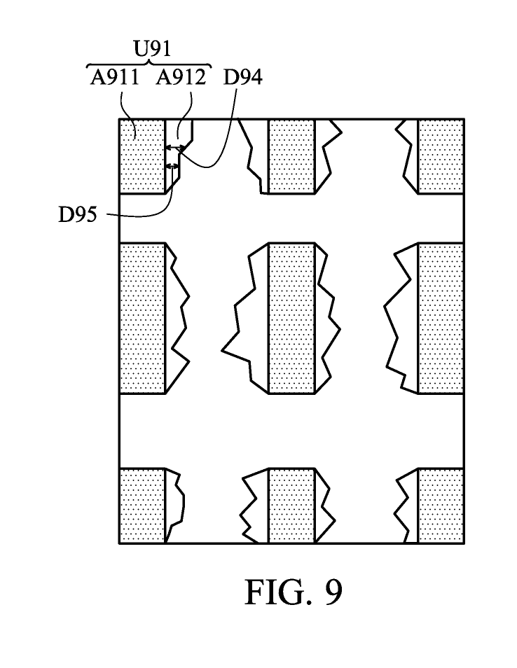

In another embodiment, as shown in FIG. 9, the pattern unit U91 has a first base pattern A911 and a first compensation pattern A912, the first compensation pattern A912 may have a zigzag fringe, and the first compensation pattern A912 may have different extension distances D94 and D95.

In view of the foregoing, in the present disclosure, a deposition process is firstly performed by using the first shadow mask to measure the first bias and the second bias of the film so as to calculate the single side gray zone, and then a second shadow mask is designed according to the calculated single side gray zone to offset (or compensate for) the effect of film diffusion characteristics on the manufacturing process of the film. Accordingly, the film of the present disclosure can be free from the influence of film diffusion characteristics to achieve improved pattern resolution and minimize the line-width variation.

While the invention has been described by way of example and in terms of the preferred embodiments, it is to be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A compensating design method for a shadow mask, comprising:
providing a first shadow mask on a substrate, wherein the first shadow mask has a first material pattern and a first opening pattern complementary to the first material pattern; the first material pattern covers a first predetermined film opening area of the substrate; and the first predetermined film opening area has a first side and a second side opposite to the first side on an axis;
performing a deposition process by using the first shadow mask as a mask to form a film on the substrate, wherein the film has a first opening under the first material pattern; the first opening has a third side and a fourth side opposite to the third side on the axis; the first side is adjacent to the third side; and the second side is adjacent to the fourth side,
wherein the distance between the first and third sides is a first bias, and the distance between the second and the fourth sides is a second bias, and a first single side gray zone of the first opening relative to the first predetermined film opening area is substantially half of the sum of the first and second biases; and
designing a second shadow mask according to the first single side gray zone, wherein the second shadow mask is similar to, but different from, the first shadow mask; the second shadow mask has a second material pattern and a second opening pattern complementary to the second material pattern; and the size of the second opening pattern is different from that of the first opening pattern.

2. The compensating design method of the shadow mask as claimed in claim 1, wherein the second opening pattern inwardly shrinks the first single side gray zone relative to the first opening pattern.

3. The compensating design method of the shadow mask as claimed in claim 1, wherein the second opening pattern has a different shape than the first opening pattern.

4. The compensating design method of the shadow mask as claimed in claim 1, wherein a first shift of the first opening relative to the first predetermined film opening area is substantially half of the difference between the first bias and the second bias;
the first material pattern of the first shadow mask further comprises a first edge pattern on one side of the first shadow mask, the first edge pattern covers a second predetermined film opening area of the substrate, the second predetermined film opening area has a fifth side adjacent to the first predetermined film opening area on the axis,
the film further has a second opening under the first edge pattern, wherein the second opening has a sixth side adjacent to the fifth side on the axis,
a distance between the fifth side and the sixth side is a third bias, a second single side gray zone of the second opening relative to the second predetermined film opening area is the substantially sum of the third bias and the first shift,
the second material pattern of the second shadow mask further comprises a second edge pattern, a portion of the second opening pattern adjacent to the second material pattern inwardly shrinks the first single side gray zone relative to the first opening pattern, and another portion of the second opening pattern adjacent to the second edge pattern inwardly shrinks the second single side gray zone relative to the first opening pattern.

5. The compensating design method of the shadow mask as claimed in claim 4, wherein the first material pattern of the first shadow mask further comprises a third edge pattern on another side of the first shadow mask, the third edge pattern covers a third predetermined film opening area of the substrate, the third predetermined film opening area has a seventh side adjacent to the first predetermined film opening area on the axis,
the film further has a third opening under the third edge pattern, wherein the third opening has a eighth side adjacent to the seventh side on the axis,
a distance between the seventh side and the eighth side is a fourth bias, a third single side gray zone of the third opening relative to the third predetermined film opening area is the difference between the fourth bias and the first shift,
the second material pattern of the second shadow mask further comprises a fourth edge pattern, and a portion of the second opening pattern adjacent to the fourth edge pattern inwardly shrinks the third single side gray zone relative to the first opening pattern.

6. A shadow mask, comprising: a material pattern and an opening pattern complementary to the material pattern, wherein the material pattern includes a plurality of pattern units arranged in an array, the pattern units at least include a first pattern unit and a second pattern unit,
the first pattern unit has a first base pattern and a first compensation pattern extending from a fringe of the first base pattern toward the opening pattern along an axis, the second pattern unit has a second base pattern and a second compensation pattern extending from a fringe of the second base pattern toward the opening pattern along the axis,
wherein the size and the shape of the first base pattern is the same as that of the second base pattern, and the extension distance of the first compensation pattern is not equal to the extension distance of the second compensation pattern.

7. The shadow mask as claimed in claim 6, wherein the pattern units further include a third pattern unit, and the third pattern unit has a third base pattern and a third compensation pattern extending from a fringe of the third base pattern toward the opening pattern along the axis, the first base pattern, the second base pattern, and the third base pattern have the same shape and size, the third base pattern is connected to the second base pattern, and the extension distance of the first compensation pattern, the extension distance of the second compensation pattern, and the extension distance of the third compensation pattern are different from each other.

8. The shadow mask as claimed in claim 6, wherein the shadow mask is used in a deposition process to form a film on a substrate, the film has a plurality of openings arranged in an array, the openings have the same shape and size, the pattern units are respectively on the openings, and an area of the first base pattern is substantially equal to that of the opening under the first base pattern.

9. The shadow mask as claimed in claim 6, wherein the first compensation pattern has a straight fringe.

10. The shadow mask as claimed in claim 6, wherein the first compensation pattern has a zigzag fringe.

11. The shadow mask as claimed in claim 10, wherein the first compensation pattern has different extension distances.
